(19) United States
(12) Patent Application Publication
(10) Pub. No.: US 2009/0251101 A1
(43) Pub. Date: Oct. 8, 2009

(54) HOLSTER FOR CHARGING PECTORALLY-IMPLANTED MEDICAL DEVICES

(75) Inventors: William C. Phillips, Brooklyn Center, MN (US); Rajeev M. Sahasrabudhe, Maple Grove, MN (US)

Correspondence Address: MEDTRONIC, INC., 710 MEDTRONIC PARKWAY NE, MINNEAPOLIS, MN, 55432-9924, US

(73) Assignee: Medtronic, Inc., Minneapolis, MN (US)

(21) Appl. No.: 12/061,055

(22) Filed: Apr. 2, 2008

(51) Int. Cl. H02J 7/00; A45F 3/02

(52) U.S. Cl. 320/108; 224/660

(57) ABSTRACT

A holster that may be donned for charging a pectorally-implanted implantable medical device (IMD) on the patient's right or left side. The holster includes a torso strap that encircles a patient's torso. The torso strap includes first and second ends and an intermediate portion there between. A shoulder strap is provided that extends over either the right or left shoulder of a patient. The shoulder strap includes a holder to house at least an antenna portion of an external charging device used to charge the IMD. The shoulder strap includes first and second ends, at least one of which may be selectably positioned at any point along the intermediate portion of the torso strap to maintain the antenna of the recharger in close proximity to the IMD to reduce charge times.

### RELATED APPLICATIONS

The present application includes some subject matter in common with the following co-pending applications, all of which are assigned to the assignee of the present application: U.S. patent application Ser. No. 11/741,038 filed Apr. 27, 2007, entitled “Holster for Charging Pectorally Implanted Medical Devices” which is a continuation-in-part of U.S. patent application Ser. No. 11/414,155 filed Apr. 28, 2006, entitled “Holster for Charging Pectorally Implanted Medical Devices”.

### FIELD OF THE INVENTION

The present invention relates to a holster for charging pectorally-implanted medical devices.

### BACKGROUND OF THE INVENTION

Implantable Medical Devices (IMDs) for producing a therapeutic result in a patient are well known. For example, implantable neurostimulators are available for the treatment of pain, movement disorders such as Parkinson's disease, essential tremor, dystonia, gastric disorders, incontinence, sexual disfunction, and other conditions. Other examples of IMDs include, but are not limited to, implantable drug infusion pumps, cardioverters, cardiac pacemakers, defibrillators, and cochlear implants.

All of the foregoing types of IMDs require electrical power to perform their therapeutic function, which may include driving an electrical infusion pump, providing an electrical neurostimulation pulse, or providing an electrical cardiac stimulation pulse. This electrical power is derived from a power source.

Typically, a power source for an IMD can take one of two forms. The first form utilizes an external power source that transcutaneously delivers energy via wires or radio frequency energy. However, having electrical wires that perforate the skin is disadvantageous due, in part, to the risk of infection. Further, continuously coupling patients to an external Power source for therapy is a large inconvenience.

The second type of power source utilizes single cell batteries to provide energy to the IMD. This can be effective for low-power applications such as pacing devices. However, such single cell batteries usually do not supply the lasting power required to perform therapies provided by newer IMDs. In some cases, such as an implantable artificial heart, a single cell battery might last the patient only a few hours. In other, less extreme cases, a single cell unit might expel all or nearly all of its energy in less than a year. This will necessitate the explant and re-implant of the IMD.

One mechanism that addresses the foregoing limitations allows electrical power to be transcutaneously transferred through the use of inductive coupling. The transferred electrical power can optionally be stored in a rechargeable battery. This battery can then be used to provide direct electrical power to the IMD. When the battery has expended, or nearly expended, its capacity, the battery can be recharged transcutaneously.

Transcutaneous energy transfer through the use of inductive coupling involves the placement of two coils positioned in close proximity to each other on opposite sides of the skin (i.e., cutaneous boundary). One of these coils is external to the patient, and is placed against the patient's skin in the vicinity of the IMD. This external, or primary, coil is associated with an external power source. A secondary coil is implanted within the patient, and may be part of the IMD or otherwise associated therewith.

In one embodiment, the primary coil is driven by the external power source with an alternating current. This induces a current in the secondary coil through inductive coupling. This induced current may be used to power the IMD and/or to charge or recharge an internal power source.

For IMDs, the efficiency at which energy is transcutaneously transferred may be crucial for several reasons. First, the inductive coupling has a tendency to heat surrounding components and tissue. Since it is desirable to limit this heating effect, the amount of energy transfer per unit time must also be limited. The higher the efficiency of energy transfer, the more energy that can be transferred while at the same time limiting the heating of surrounding tissue.

In addition to the foregoing, it is desirable to limit the amount of time required to achieve a desired charge, or recharge, of an internal power source. While charging or recharging is occurring, the patient necessarily has an external encumbrance attached to his or her body. This attachment may impair the patient's mobility and limit the patient's comfort. The higher the efficiency of the energy transfer system, the faster the desired charging or recharging may be completed, thus limiting inconvenience to the patient.

Finally, the amount of energy available to the IMD may be limited by the amount of time the patient is willing to devote to recharging the device. The higher the efficiency of the energy transfer system, the greater the amount of energy that can be transferred during this limited amount of time. This increases the practical size of the internal power source, and allows for use of IMDs having higher power use requirements. This may also extend the time between charging.

What is needed is an energy transfer system that addresses at least some of the above-described considerations.

### SUMMARY OF THE INVENTION

One aspect of the present invention provides a holster adapted to receive a power source for transcutaneously powering pectorally-implanted IMDs in a patient having a torso and a shoulder. In one embodiment the holster includes a torso strap portion adapted to receive the torso of the patient. The torso strap includes first and second ends and an intermediate portion. The first and second ends of the torso strap may include a fastener to retain the torso strap around the patient's torso.

The holster also includes a shoulder strap that engages the torso strap. The shoulder strap is operatively connected to a holder. The holder is adapted to receive a power source for recharging a power source carried by the IMD. In one embodiment, the holder is adapted to carry an antenna that houses a primary coil. Once positioned within the holder, the antenna is located in close proximity to a secondary coil of an IMD. An external charging unit generates a current in the primary coil to inductively couple the primary coil with the secondary coil of the IMD, thereby recharging the power source of the IMD.

The shoulder strap includes first and second ends that are adapted to engage the torso strap. At least one of these ends is selectively positionable at any point along the intermediate portion of the torso strap that is not otherwise occupied by the other end of the shoulder strap. As an example, in one embodiment, the second end of the shoulder strap may be selectively positioned at any point along the intermediate portion of the torso strap that is not otherwise occupied by the first end of the shoulder strap. In another embodiment, the first end of the shoulder strap may be selectively positioned at any point along the intermediate portion of the torso strap not otherwise occupied by the second end. In yet another embodiment, each of the first and second ends may be selectively positioned to occupy any selected point along the intermediate portion of the torso strap not otherwise occupied by the other end. The foregoing types of adjustments may be made with, or without, the first and second ends of the torso strap coupled together. This high degree of adjustability allows the holder of the holster to be readily positioned at an optimal location in the vicinity of a pectorally-implanted IMD. This provides for maximum recharge efficiency and a decrease in recharge time.

In one embodiment, the shoulder strap includes a back portion that has an adjustable length. By varying the length of the back portion, the position of holder may be further adjusted to ensure an antenna housed in the holder is in an optimal position relative to the IMD.

In another embodiment, the shoulder strap further includes a front portion, and the holder may be coupled to, or include, a strap. The strap of the holder may be adjusted relative to the front portion of the shoulder strap. This allows the patient to select the height at which the torso strap encircles his torso, and provides for greater patient comfort.

According to another aspect of the invention, the shoulder strap may include a vest to encircle at least a portion of the patient's back. The vest may be padded to enhance patient comfort.

The invention may further include a holder to carry the external charging unit. This holder may include a clip that couples to a support structure such as the torso strap, a belt worn by the patient, a pocket of the patient's clothing, or any other similar structure. This allows the external charging unit to be conveniently supported when the antenna is positioned within the holder of the shoulder strap.

One aspect of the invention provides a holster adapted to receive a power source for transcutaneously powering a pectorally-implanted IMD. The holster includes a torso strap adapted to receive the torso of a patient. This torso strap has first and second ends and an intermediate portion therebetween. A shoulder strap is adapted to receive the shoulder of the patient. This shoulder strap has a first end operatively coupled to the intermediate portion of the torso strap. A second end of the shoulder strap is selectively positionable anywhere along the intermediate portion of the torso strap. The shoulder strap is adapted to support at least an antenna portion of the power supply in a position that is adjacent to the pectorally-implanted IMD.

A method of transcutaneously powering a pectorally-implanted IMD with a power source is also disclosed. The method includes donning a torso strap that has a first end, a second end releaseably coupled to the first end, and an intermediate portion between the first end and the second end. The method further includes donning a shoulder strap supporting at least an antenna of the power source. The shoulder strap has a first end and a second end, each of which is coupled to the intermediate portion of the torso strap. The second end of the shoulder strap is then selectively positioned to any location along the intermediate portion of the torso strap to allow the antenna of the power source to be optimally placed proximate to the pectorally implantable IMD.

Another embodiment provides a holster adapted to receive a power source for transcutaneously powering a pectorally-implanted IMD implanted within a patient. The holster includes a shoulder strap having a first end and a second end and being adapted to support at least an antenna of the power source. The holster also includes a torso strap having a first end, a second end, and an intermediate portion there between. The first end of the shoulder strap is coupled to the intermediate portion. The second end of the shoulder strap is likewise coupled to, and is selectively positionable along, all points of the intermediate portion not occupied by the first end of the shoulder strap.

Other scopes and aspects of the current invention will become apparent to those skilled in the art from the following description and the accompanying drawings.

### BRIEF DESCRIPTION OF THE DRAWINGS

FIG. 1 is a perspective diagram illustrating an implantable medical device implanted in a patient.

FIG. 2 is a schematic cross-sectional side view of an external antenna and an implantable medical device implanted in a patient.

FIG. 3A is a front view of a patient donning a holster on the patient's left side according to one embodiment of the invention.

FIG. 3B is a front view of a patient donning a holster on the patient's right side according to one embodiment of the invention.

FIG. 4A is a back view of a patient donning a holster on the patient's left side in the manner shown in FIG. 3A.

FIG. 4B is a back view of a patient donning a holster on the patient's right side in the manner shown in FIG. 3B.

FIG. 5 is a perspective view of the front portion of the shoulder strap.

FIG. 6 is an exploded perspective view of the holder of the shoulder strap.

FIG. 7 is a perspective view of the holder of the shoulder strap showing a tab of the holder pulled back to expose a pocket provided by the holder.

FIG. 8 is a perspective view of a back portion of the shoulder strap showing the shoulder strap engaging the torso strap.

FIG. 9 is a front perspective view of the holder coupled to the back portion of the shoulder strap.

FIG. 10 is a front perspective view of the holder coupled to the front and back portions of the shoulder strap, and illustrating the shoulder strap engaging the torso strap.

FIGS. 11A through 11C are close-up views of an adjuster.

FIG. 12 is a front perspective view illustrating one embodiment of an external charging device.

FIG. 13 is a front perspective view of a patient donning the holster on the patient's right side.

FIG. 14 is a front perspective view of the patient who has positioned the shoulder strap over his right shoulder.

FIG. 15 is a front perspective view of the patient adjusting the length of the torso strap.

FIG. 16 is a front perspective view illustrating the patient inserting an antenna of an external charging device into the pocket formed between the two panels of the holder.

FIG. 17 is a front perspective view of the patient holding the charging unit of a charging device after the antenna has been positioned in the holder.

FIG. 18 is a front perspective view of the patient who has donned the holster on his left side.

FIG. 19A is a front perspective view of optional holder for housing a charging unit of an external charging device.

FIG. 19B is a back view of the optional holder for housing the charging unit.

FIG. 19C is a side view of a clip that may optionally be used to attach the holder for the charging unit to the torso strap, a belt, a pocket, or some other suitable connecting structure.

### DETAILED DESCRIPTION OF A PREFERRED EMBODIMENT

The current invention relates to a holster for charging pectorally-implanted Implantable Medical Devices (IMDs). The term “charge” refers to any type of charge including, but not limited to, an initial charge and a recharge. The pectoral region is preferably proximate the pectoral muscles and is more preferably within a region of the body below the clavicle, above the xiphoid process of the sternum, and between the sternum and the axilla, which is a cavity beneath the junction of the arm and the torso. An example of a suitable pectorally-implanted medical device for use with the present invention is disclosed in U.S. Patent Publication No. US 2005/0245996 A1, published Nov. 3, 2005, entitled “Spacers for Use with Transcutaneous Energy Transfer System”.

One embodiment of the holster includes a torso strap and shoulder strap. The torso strap includes first and second ends and an intermediate portion there between. The first and second ends of the torso strap are adapted to be coupled to one another to maintain the torso strap around the patient's torso.

The shoulder strap includes first and second ends. At least one of the first and second ends of the shoulder strap is selectively positionable at any point along the intermediate portion of the torso strap that is not otherwise occupied by the other end of the shoulder strap. This provides for optimal placement of a holder that is carried by the shoulder strap, and that is provided to receive an antenna of an external charging device. This optimal placement of the holder supports optimal energy transfer between the antenna and a coil within the pectorally-implanted IMD.

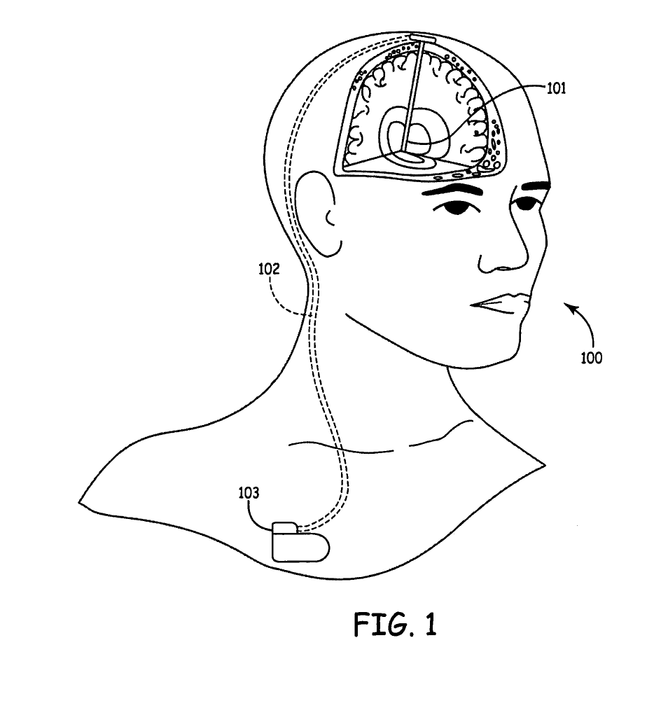

FIG. 1 is a perspective diagram illustrating an IMD 103 implanted in a patient 100. This IMD may be a neurostimulator used for the treatment of a movement disorder such as Parkinson's Disease, essential tremor, and dystonia, for example. The IMD is implanted in the pectoral region of the patient 100, typically by a surgeon in a sterile surgical procedure performed under local, regional, or general anesthesia. During the sterile surgical procedure, a catheter 102 is typically implanted with the distal end positioned at a desired therapeutic delivery site 101 and the proximal end tunneled under the skin to the location where the pectorally-implanted IMD 103 is implanted. The pectorally-implanted IMD 103 can be any suitable IMD such as, but not limited to, implantable neurostimulators, implantable drug infusion pumps, implantable cardioverters, implantable cardiac pacemakers, implantable defibrillators, and cochlear implants.

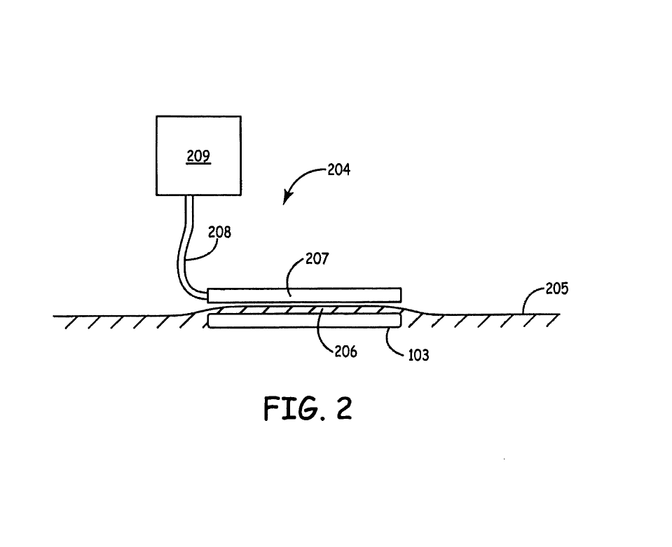

The pectorally-implanted IMD 103 includes a rechargeable power source that can be charged via an external charging device while the pectorally-implanted IMD 103 is implanted in a patient. This type of external charging device, also referred to as a “recharger”, may include an external antenna and a charging unit, as discussed further in regards to FIG. 2.

FIG. 2 is a schematic cross-sectional side view of an external antenna 207 of an external charging device in proximity to IMD 103. IMD 103 has been pectorally-implanted in a patient under cutaneous boundary 205. As shown in FIG. 2, the pectorally-implanted IMD 103 usually leaves an area of the patient's body that is not quite as flat as it was before implantation. This results in a “bulging area” 206 proximate the surface of the patient's skin which bulges outward somewhat to accommodate the bulk of the pectorally-implanted IMD 103.

Depending upon the application and the type of pectorally-implanted IMD 103, the IMD is generally implanted subcutaneously at depths of from 1 centimeter (0.4 inches) to 2.5 centimeters (1 inch) where there is sufficient tissue to support the implanted system. However, the locations of the implantation vary from patient to patient. The amount of bone and the amount of soft tissue between the bone and the cutaneous boundary 205 are factors that affect the actual depth of implant. The actual depth of implant as well as the amount of soft tissue at, and around, the implant site affects the size and shape of bulging area 206 at the implant site. Further, the location of the pectorally-implanted IMD may vary in the patient due to any movement of the IMD, any weight loss or gain by the patient, or any loss or gain of muscle mass by the patient, especially if the IMD is not sutured into place.

Bulging area 206 is an aid to locating, and placing external antenna 207, in the proximity of pectorally-implanted IMD 103. External antenna 207 is coupled via cable 208 to an external charging unit 209 of charging device 204. External charging unit 209 drives a primary coil in the external antenna 207 with an oscillating current. This induces a current in a secondary coil contained within, or associated with, the pectorally-implanted IMD 103.

The type of transcutaneous energy transfer system discussed above can be utilized over extended periods of time, either to power the pectorally-implanted IMD 103 or to charge a replenishable power supply within the pectorally-implanted IMD 103. Over the period of time during which the charging unit 209 is utilized, antenna 207 is affixed to the patient's body. The patient may be attempting to continue a normal routine, such as by making normal movements or by sleeping. A holster according to the current invention is provided to maintain the antenna in a stationary position relative the patient's pectoral region while patient movement occurs. This holster is preferably conformal and flexible in order to conform to the shape of the patient's pectoral region.

Before continuing, it will be understood that the embodiment shown in FIG. 2 is merely exemplary. It is also recognized that the charging unit 209 and the antenna 207 may be contained in a common housing rather than in separate housings. Suitable charging units include without limitation those described in U.S. Patent Publication Nos. 2005/0113887; 2005/0075700; 2005/0075699; 2005/0075698; 2005/0075697; 2005/0075696; 2005/0075694; and 2005/0075693; all of which are incorporated herein by reference.

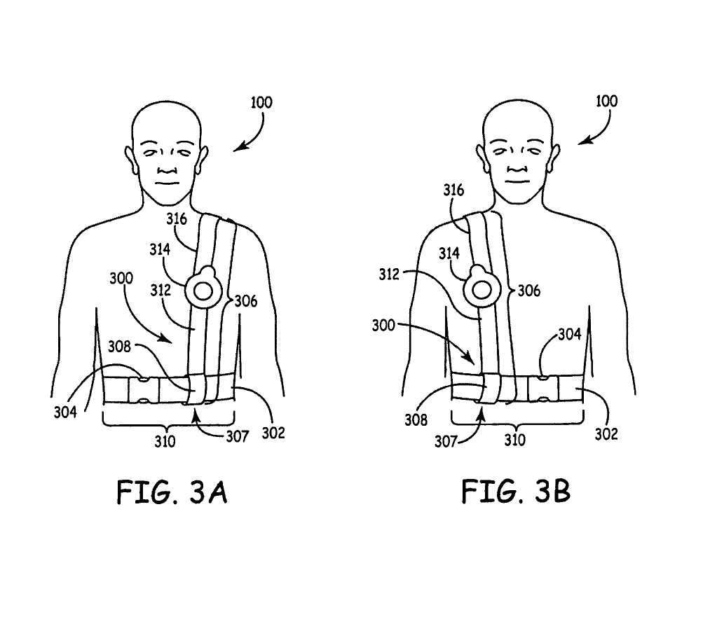

FIG. 3A is a front view of a patient 100 donning a holster 300 according to one embodiment of the current invention. The holster is shown positioned on the patient's left side. Holster 300 includes a torso strap 302 that extends around the torso of the patient. The torso strap may be adjusted to sit in the vicinity of the patient's waist. Alternatively, the patient may prefer to adjust torso strap 302 to sit either above or below the waist-line.

Torso strap 302 includes a fastener 304. As discussed below, in the exemplary embodiment, this fastener 304 comprises a male portion that snaps into a female portion. In other embodiments, fastener 304 may be a buckle, snap, button, tie, hook-and-eye mechanism, and/or hook-and-loop enclosure mechanism such as VELCRO® fasteners. Any other suitable retaining mechanism that retains torso strap 302 around the torso of the patient may be used in the alternative.

Holster 300 further includes a shoulder strap 306 that engages the torso strap 302 in an adjustable manner. In the embodiment shown in FIG. 3A, shoulder strap 306 terminates at one end 307 in a loop 308. Loop 308 of shoulder strap slidably engages torso strap 302 so that the loop may be positioned at any point along the entire front 310 of the torso strap. Moreover, loop 308 may be further positioned along the back of the torso strap (not shown in FIG. 3A), if desired. This is discussed further below.

In the illustrated embodiment, loop 308 is sized to be capable of sliding over fastener 304 so that end 307 may be positioned at a desired point on the torso strap 302 without disconnecting the fastener. Other mechanisms for adjustably coupling torso strap 302 to shoulder strap 306 are described below.

Shoulder strap 306 of one embodiment is comprised of a front portion 312 that terminates in loop 308, a holder 314, and a back portion 316 that extends over the patient's shoulder. The holder 314 is adapted to receive at least antenna portion 207 of external charging device 204 that is used to recharge a pectorally-implanted IMD.

FIG. 3B is a front view of a patient donning a holster on the patient's right side according to one embodiment of the invention. The view is similar to that shown in FIG. 3A above, except that the holder 314 has been positioned over the patient's right pectoral region to recharge a device that has been implanted in that area.

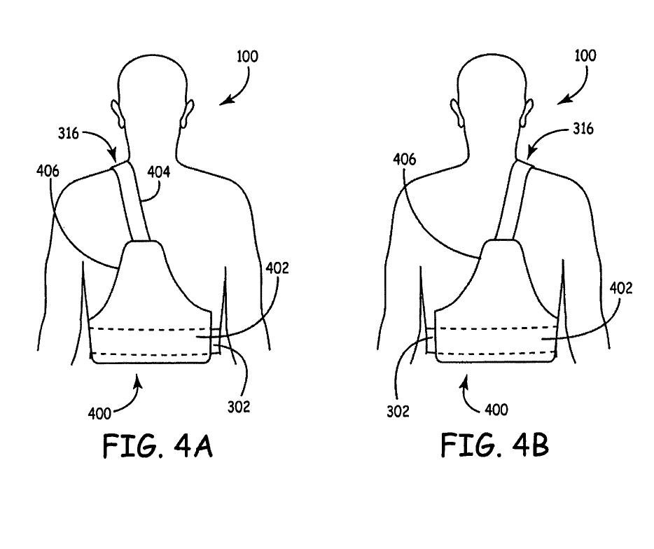

FIG. 4A is a back view of a patient donning holster 300 on the patient's left side in the manner shown in FIG. 3A. In this view, back portion 316 of shoulder strap 306 is positioned over the left shoulder. In particular, back portion 316 of the shoulder strap 306 extends from the left pectoral region over the left shoulder to the patient's back.

Back portion 316 terminates in an end 400 which adjustably engages torso strap 302. For example, end 400 may include a pocket 402 (shown dashed) that slidably receives torso strap 302. This allows back portion 316 to be adjusted for comfort as the patient adjusts shoulder strap 306 from one shoulder to the next. For instance, in FIG. 4A, end 400 is slid to the left side of the patient's back to accommodate the position of back portion 316 of shoulder strap 306 over the patient's left shoulder.

In the illustrated embodiment, the back portion 316 of the shoulder strap 306 includes a strap 404 that engages the patient's shoulder and a vest 406. Vest 406 is shown to be generally triangular in shape, but may take any other format. In one embodiment, vest 406 is fashioned of nylon, polyester, leather, cotton, or some other durable, moisture-resistant material. The vest may additionally or alternatively be fashioned of cushioned or quilted materials which may be moisture-wicking to enhance patient comfort. Some portion of vest may be made of elastic material.

FIG. 4B is a back view of a patient donning holster 300 on the patient's right side in the manner shown in FIG. 3B. This view is substantially similar to that shown in FIG. 4A. However, in this instance, back portion 316 of shoulder strap 306 extends from the patient's right pectoral region over the right shoulder to the patient's back. Back portion 316 adjustably engages torso strap 302 in a manner similar to that discussed above in regards to FIG. 4A. In FIG. 4B, vest 406 is adjusted toward the right side of the patient to accommodate the position of back portion 316 of shoulder strap 306 over the patient's right shoulder. If desired, vest 406 may instead be centered on the small of the patient's back rather than being off-center as shown in FIGS. 4A and 4B.

In the foregoing manner, both the first end 400 of shoulder strap 306 and the second end 307 of shoulder strap engages torso strap 302. In one embodiment, at least one of the first and second ends of shoulder strap 306 is adjustably positionable along the length of torso strap 302 to allow for optimal positioning of holder 314 with respect to the pectorally-implanted IMD.

As discussed above, in one embodiment, shoulder strap 306 comprises a front portion 312, a holder 314, and a back portion 316. These elements are considered in turn in regards to the Figures discussed below.

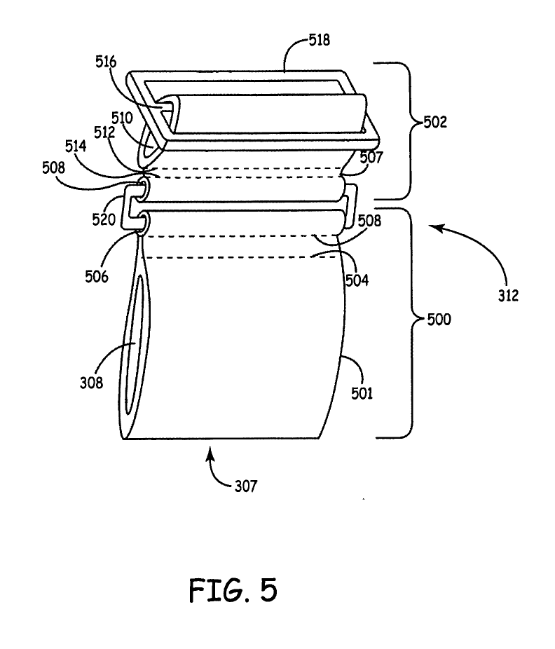

FIG. 5 is a perspective view of one exemplary embodiment of the front portion 312 of shoulder strap 306. In the illustrated embodiment, front portion 312 includes an end portion 500 and an adjuster portion 502. End portion 500 includes end 307 of shoulder strap 306. In one embodiment, end 307 provides loop 308, which may be formed by folding one end of a durable, flexible strap 501 of material back onto itself and affixing the strap in this configuration via stitching 504. Alternatively, a strap may be retained in this loop configuration using a high-strength adhesive, by providing hook-and-loop fasteners, or using any other suitable mechanism. Strap 501 may be made of any type of durable material, including nylon, polyester, leather, cotton, elastic materials, materials that are waterproof or water resistant, and materials that are moisture-wicking.

Loop 308 is sized so that it readily slides along the entire length of torso strap 302, including the entire front portion 310 of torso strap, without the need to disconnect fastener 304 of torso strap. If desired, loop 308 of shoulder strap 306 may be positioned along any portion of torso strap not occupied by end 400 of shoulder strap 306.

End portion 500 further includes a second loop 506. The second loop may be formed, for example, by folding the other end of strap 501 back onto itself and affixing the strap in this manner, as via stitching 508 or by some other suitable means such as an adhesive, as discussed above.

As discussed above, front portion 312 also includes an adjuster portion 502. Adjuster portion 502 may be constructed of a second strap 507 of durable, flexible material including, but not limited to, those materials listed above in regards to strap 501. Strap 507 may be configured to form loops 508 and 510. In a manner similar to that discussed above, each of these loops may be formed by folding each end of strap back onto itself and affixing the end with at least one line of stitching 514 and 512, respectively. Alternatively, some other mechanism such as adhesive may be used for this purpose.

Adjuster portion 502 and end portion 500 are coupled via a connector 520. In particular, loop 508 of adjuster portion 502 encircles one side of a connector 520. Another side of connector 520 is encircled by loop 506 of end portion 500. Loop 308 of end portion is available to engage torso strap 302, as discussed above.

As discussed above, adjuster portion 502 may be configured to include a second loop 510. This loop 510 may be coupled to an adjuster 518. In one embodiment, loop 510 engages the middle bar 516 of adjuster 518. Adjuster 518 is used to adjust the length of shoulder strap 306 in a manner to be discussed below.

In the foregoing embodiment, front portion 312 is formed by two straps joined by connector 520. In other embodiments, a single strap may be employed instead. For instance, ends of a single strap may be formed into loops 510 and 308, with loop 510 engaging adjuster 518 and loop 308 receiving torso strap 302. This alternate embodiment eliminates connector 520. Other types of adjusters may be utilized instead of that illustrated for adjuster 518. Many other embodiments will be apparent to those skilled in the art.

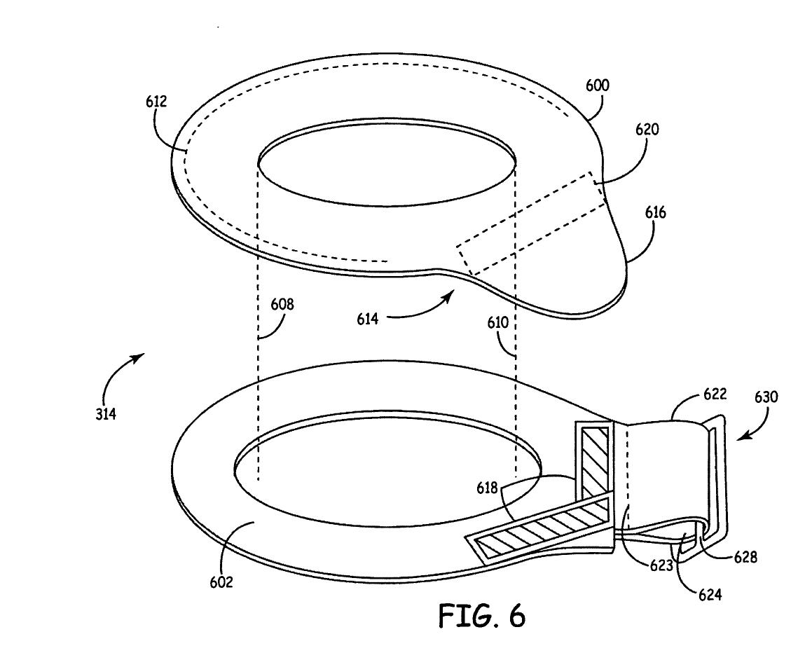

FIG. 6 is an exploded perspective view of holder 314 of shoulder strap 306. Holder 314 is adapted to receive at least antenna 207 of external charging device 204 that is used to charge or recharge a rechargeable power source within pectorally-implanted IMD 103. Holder 314 includes a first panel 600 and a second panel 602. Both panels may be formed of a flexible, durable, non-abrasive fabric including, but not limited to, polyester, nylon, leather or cotton. Optionally, the fabric is moisture-wicking to enhance patient comfort.

In the illustrated embodiment, panels 600 and 602 are generally annular. Both panels have an inner and an outer diameter. The outer diameter of panel 600 is substantially the same as the outer diameter of panel 602. However, in this embodiment, inner diameter of panel 602 is larger than the inner diameter of panel 602, as indicated by dashed lines 608 and 610. This provides for better contact between antenna 207 and patient 100 when holster 300 is donned and antenna 207 is housed between panels 600 and 602.

Panels 600 and 602 are affixed to one another along a portion of their outer diameters, as indicated by dashed line 612 of panel 600. The panels may be affixed to one another in this manner by stitching, adhesive, snaps, buttons, stapling, or some other mechanism. In a preferred embodiment, the panels will be so affixed permanently along dashed line 612, although in another implementation, they may be releaseably attached along dashed line 612.

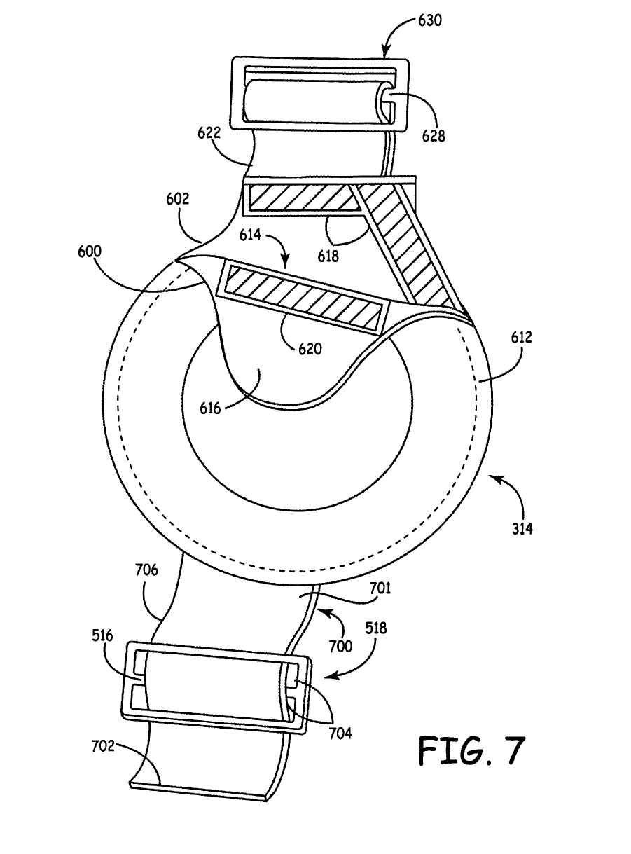

When panels 600 and 602 are affixed generally along dashed line 612, the panels form a pocket or cavity that has an opening 614. Opening 614 is accessible via tab 616. In particular, tab 616 may be grasped and pulled away from panel 602 to spread panel 600 apart from panel 602. This allows for the insertion of antenna 207 of external charging device 204 through opening 614 into the pocket or cavity between panels 600 and 602, as is shown in FIG. 7 to be discussed below.

After antenna 207 of external charging device 204 has been inserted into the pocket formed between panels 600 and 602, the pocket may be fastened closed. In one embodiment, this is accomplished using strips formed of hook-and-loop fasteners such as VELCRO® fasteners. For instance, panel 602 includes hook-and-loop strips 618. These strips may be affixed to panel 602 using stitching, adhesive, or some other mechanism. Likewise, one or more strips of hook-and-loop fasteners may be provided on the underside of panel 600 adjacent to strips 618. For example, a strip 620 (shown dashed) of hook-and-loop fasteners may be provided on the underside of panel 600. Strip 620 engages strips 618 of panel 602 when tab 616 is pressed into contact with panel 602, thereby fastening the opening of the pocket closed to retain antenna 207. Other fasteners may be used instead of, or in addition to, the hook-and-loop strips to retain tab 616 in a closed position. Such fasteners may include snaps, buttons, hook-and-eye fasteners, ties, and so on.

In one embodiment, panel 602 has a strap 622 extending from an edge adjacent to strips 618. Strap 622 may be folded back onto itself and retained in place by stitching 623, or using some other mechanism. Strap 622 thereby forms a loop 624. This loop may encircle a middle bar 628 of an adjuster 630. In one embodiment, adjuster 630 attaches holder 314 to holster 300 in an adjustable manner, as will be shown in the remaining drawings.

FIG. 7 is a perspective view of holder 314 showing panels 600 and 602 affixed to one another, and showing tab 616 pulled back to expose opening 614. As discussed above, antenna 207 of external charging device 204 will be inserted through opening 614 into the pocket formed by panels 600 and 602 having been affixed substantially along dashed line 612.

FIG. 7 further illustrates that holder 314 may include strap 700. Strap 700 includes a first end 701, a second end 702, and an intermediate portion 706 extending there between. First end 701 of strap 700 may be attached to panels 600 and 602 via stitching or some other mechanism. Second end 702 of strap 700 is threaded through slots 704 of adjuster 518 (FIG. 5). Adjuster 518 may then be positioned anywhere along intermediate portion 706. In this manner, strap adjustably attaches holder 314 to front portion 312 of shoulder strap 302.

FIGS. 6 and 7 provide one embodiment of holder 314. Those skilled in the art will recognize many alternative embodiments may be provided. For instance, adjusters 630 and 518 may be replaced with other types of fasteners. If desired, both adjusters 630 and 518 and straps 622 and 700 may be replaced by other connection means to connect panels 600 and 602 of holder 314 to front portion 312 and back portion 316 of shoulder strap 306. Such connection means may include various types of hooks, clips, clasps, snaps, and/or other fasteners coupled to one or more of panels 600 and 602 that engage an opposing connection member on the front portion 312 and/or the back portion 316. Moreover, as already discussed, hook-and-loop strips 618 and 620 may be replaced with other types of fasteners. Panels 600 and 602 need not be annular but may instead take other shapes and sizes. Thus, holder 314 is merely one of many configurations that may be used with holster 300.

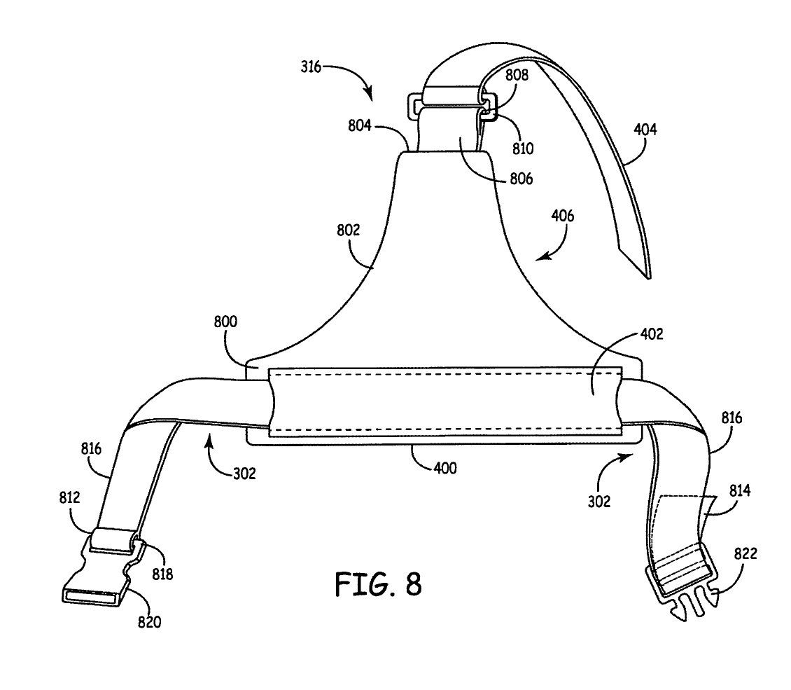

FIG. 8 is a perspective view of back portion 316 of shoulder strap 306, with the back portion engaging torso strap 302. As was shown in FIGS. 4A and 4B, back portion 316 includes a vest 406. In the illustrated embodiment, the vest includes a rectangular base portion 800 that terminates in end 400, providing a first end of shoulder strap 302. Vest 406 also includes a triangular portion 802 that may have concave sides and extend upward from rectangular base portion 800. Vest may be of another shape and/or size, if desired.

Triangular portion 802 of vest 406 includes a top 804 which is coupled to a strap 806. Top 804 may be coupled to strap 806 via stitching, adhesive, or some other mechanism. Strap 806 may be folded back onto itself to form a loop 808 which encircles a connector 810. Alternatively, strap 806 may be coupled to connector 810 in another manner. Connector 810 is further coupled to one end of another strap, strap 404 (FIG. 4). As discussed above, strap 404 is provided to extend over a patient's shoulder when holster 300 is donned. In one embodiment, strap 404 and connector 810 are coupled by a loop formed in one end of strap 404 that encircles connector 810. This loop may be formed by folding the end of strap 404 back onto itself and affixing strap 404 in this position with stitching, adhesive, or another mechanism.

Rectangular portion 800 of vest 406 includes a pocket 402. This pocket may be formed by affixing a panel of material to rectangular base portion, as via stitching, adhesive, or another mechanism. Alternatively, pocket 402 may be formed by folding end 400 back onto itself and affixing to rectangular portion 800 with stitching or some other mechanism.

FIG. 8 shows torso strap 302 extending through pocket 402 of back portion 316. Torso strap 302 includes a first end 812, a second end 814, and an intermediate portion 816 extending there between. In one embodiment, a loop 818 is formed at the first end 816 by folding the end back onto itself and affixing with stitching or adhesive. In one embodiment, loop 818 is coupled to a female portion 820 of fastener 304 (FIG. 3).

As discussed above, torso strap 302 further includes a second end 814 that is coupled to a male portion 822 of fastener 304. This may be accomplished by threading second end 814 of torso strap 302 through slots provided on male portion 822 of fastener 304 and pulling on the second end 814 of the torso strap. This positions male portion 822 of fastener 304 at a desired point along intermediate portion 816 of torso strap 302. When vest 406 is donned, male portion 822 of fastener 304 can be received by, and snapped into position within, female portion 820 to retain torso strap 302 around the patient's torso. This will be discussed further below.

Pocket 402 of vest 406 is sized to adjustably receive torso strap 302, as shown in FIG. 8. In one embodiment, torso strap 302 readily slides through pocket 402 all along intermediate portion 816.

It will be recognized that FIG. 8 provides one exemplary embodiment of back portion 316 of shoulder strap 306, and other embodiments are possible. For instance, strap 806 may be eliminated and an end of strap 404 may be coupled to top 804 of vest 406. In another embodiment, top 804 may extend into an elongated portion that provides the strap such that vest 406 and strap are one element. Other types of fasteners may be used. For instance, fastener 304 having male portion 822 and female portion 820 may be replaced by hook-and-loop strips that are affixed to first end 812 and that may engage other hook-and-loop strips along various points of intermediate portion 816 of torso strap 302. In another embodiment, one or more snaps on first end 812 may engage a selected one of receiving members located along various points of intermediate portion 816 and/or at end 814. Preferably, the fastening mechanism that is selected supports the ability to adjust the length of torso strap 302 so that the strap may accommodate patients having varying girths. Other embodiments will be apparent to those skilled in the art.

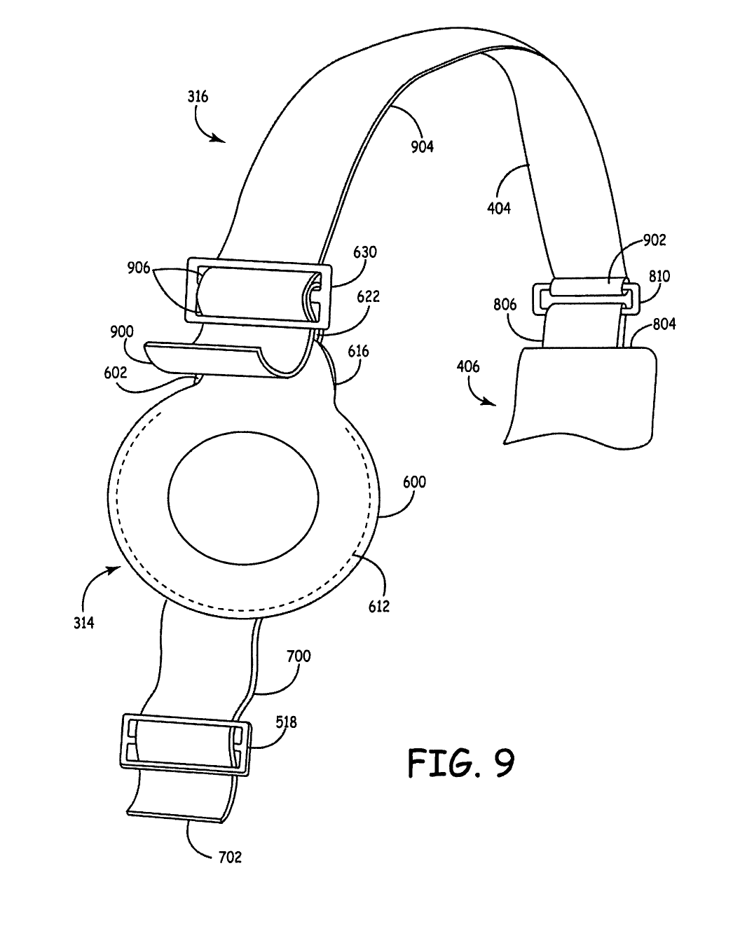

FIG. 9 is a front perspective view of holder 314 coupled to back portion 316. As discussed above, in one embodiment back portion 316 includes strap 404 for extending over a patient's shoulder. Strap 404 is coupled to top 804 of vest 406 (not shown in its entirety in FIG. 9.) In one embodiment, strap 404 is coupled to top 804 of vest 406 via connector 810 and strap 806 in the manner shown in FIG. 8.

Strap 404 includes a first end 900, a second end 902 that is coupled to connector 810, and an intermediate portion 904 that extends between the first and second ends. Strap 404 is coupled to adjuster 630 of holder by threading first end 900 of strap 404 through slots 906 of adjuster 630 and pulling on first end 900. This positions adjuster 630 at a desired point along intermediate portion 904 of strap 404. In this manner, the length of strap 404 between connector 810 and adjuster 630 is variable so that holder 314 may be optimally positioned over bulging area 206 created by pectorally-implanted IMD 103. This reduces recharge time of IMD 103.

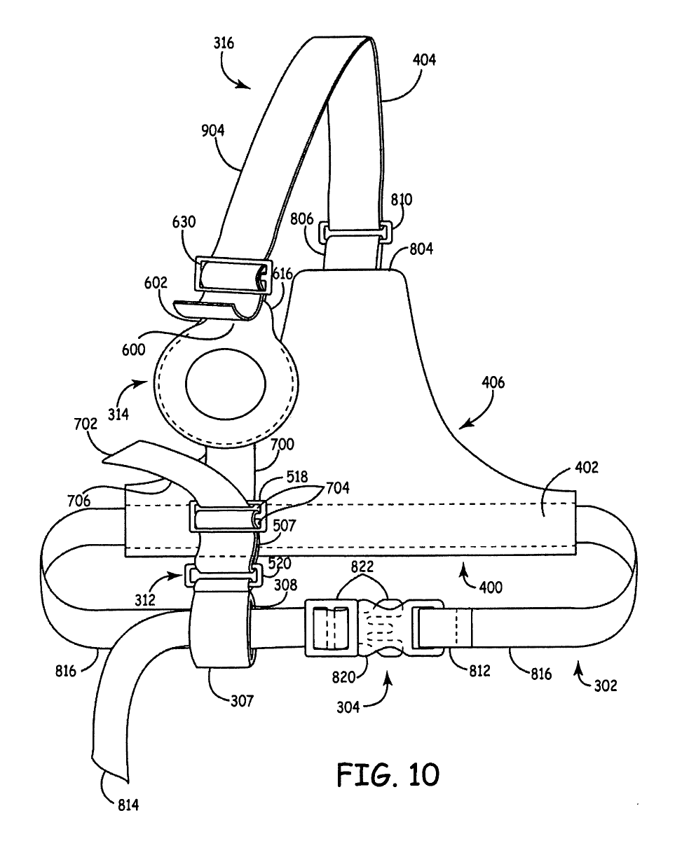

FIG. 10 is a front perspective view of holder 314 coupled to back portion 316 and front portion 312. As shown in FIG. 7, strap 700 is coupled to holder 314. End 702 of strap 700 is shown threaded through one of slots 704 of adjuster 518. For ease of reference, end 702 is not shown threaded through the other of slots 704 of adjuster 518. However, it is understood that during use, end 702 of strap is threaded through both slots 704 of adjuster 518. This couples holder 314 to front portion 312 in an adjustable manner. In particular, end of 702 of strap may be pulled to adjust the distance between holder 314 and end 307 of shoulder strap 306. This may be used to adjust for torso lengths of patients, and to further determine the height at which torso strap 302 will encircle the patient. For instance, if a patient desires torso strap 302 to encircle his waist, the patient will adjust the distance between holder 314 and torso strap 302 so that it is longer than would be required if the torso strap 302 were instead to encircle the patient's chest area. In this manner, the length of shoulder strap 302, which includes front portion 312, holder 314, and back portion 316, is highly adjustable. The length of the shoulder strap 306 may be varied via adjusters 630 and 518.

As discussed above, torso strap 302 includes fastener 304 which is fastened to retain torso strap 302 around the patient's torso. FIG. 10 illustrates fastener 304 in the closed position. Male portion 822 of fastener 304 has been snapped into position with female portion 820 of fastener 304. End 814 of torso strap 302 is threaded through slots in male portion 822. Force may then be exerted on end 814. This positions male portion 822 at a desired point along intermediate portion 816 of torso strap 302. In this manner, the length of the torso strap is adjusted to accommodate varying torso girths.

As previously discussed, in the illustrated embodiment, shoulder strap 306 has a first end 400 that is provided by rectangular base portion of vest 406. Shoulder strap 306 further has a second end 307 that, in one embodiment, includes a loop 308. Second end 307 is adapted to be selectably positioned anywhere along intermediate portion 816 of torso strap 302 that is not otherwise occupied by first end 400. In one embodiment, loop 308 of second end 307 slidably engages torso strap 302 so that it may be positioned anywhere along the entire portion of intermediate portion 816 that is not otherwise occupied by first end 400. If desired, loop 308 may be slid over fastener 304 without disengaging male portion 822 from female portion 820.

In addition to the foregoing, in a preferred embodiment, first end 400 may likewise be selectively positioned at any point along intermediate portion 816 of torso strap that is not otherwise occupied by second end 307. In one embodiment, this involves sliding torso strap 302 through pocket 402 of vest 406 to a desired point along intermediate portion 816.

In the manner described above, the embodiment of FIG. 10 provides a highly adjustable holster having a shoulder strap 306 and a torso strap 302. The shoulder strap 306 includes a first end 400 and a second end 307. In a preferred embodiment, both ends may be adjusted anywhere along intermediate portion 816 of torso strap 302 so that the position of holder 314 may be optimally positioned over pectorally-implanted IMD 103. Similarly, adjuster 630 may be positioned at any point along intermediate portion 904 of strap 404. This allows holder 314 to be selectively positioned over the patient's pectoral area in which IMD 103 is implanted. Adjuster 518 may further be positioned at any point along intermediate portion 706 of strap 700. This allows the height at which torso strap 302 encircles a patient's torso to be adjusted based on patient preference. Holster 300 is therefore highly adjustable.

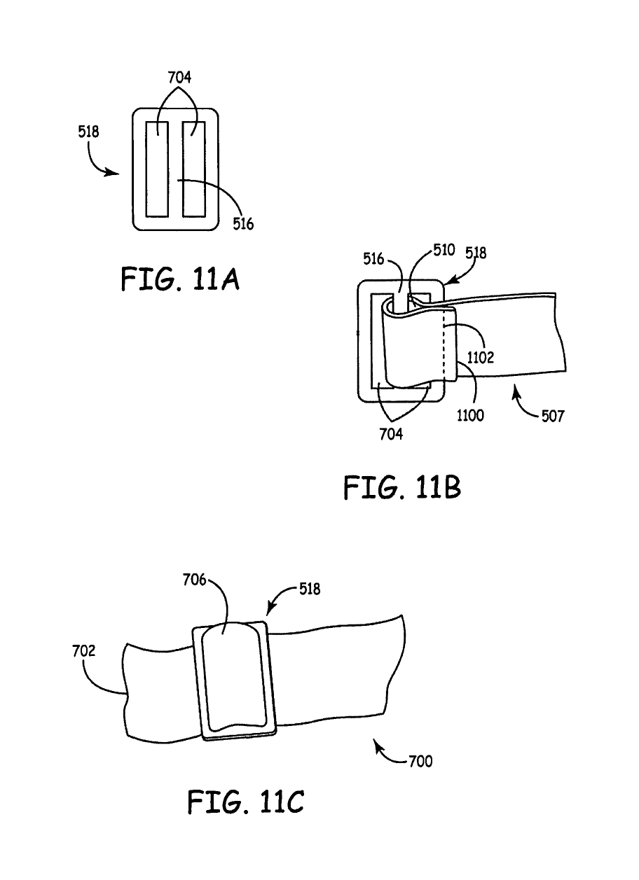

FIGS. 11A-11C are close-up views of adjuster 518. Although adjuster 518 is specifically shown and described, this discussion also relates to adjuster 630, which is similar to adjuster 518. Adjuster 518 includes a middle bar 516 and slots 704.

As shown in FIG. 11B, an end 1100 of strap 507 of adjuster portion 502 (FIG. 5) is folded back to form loop 510. End 1100 may be affixed to strap 507 via a row of stitching 1102, although end 1100 may be affixed in another manner, such as via a high-strength adhesive. End 1100 thereby forms a loop that encircles middle bar 516, attaching strap 507 to adjuster 518.

FIG. 11C illustrates how an intermediate portion 706 of strap 700 is weaved through slots 704 of adjuster 518, which is done while the middle bar 516 of adjuster is coupled to strap 507 in the manner shown in FIG. 11C. Adjuster 518 may be positioned at a desired point of intermediate portion 706 of strap 700 by exerting force on end 702 of strap 700. This allows the length of front portion 312 of shoulder strap 306 to be selectively adjusted. This determines the height at which torso strap 302 will engage the torso of patient 100.

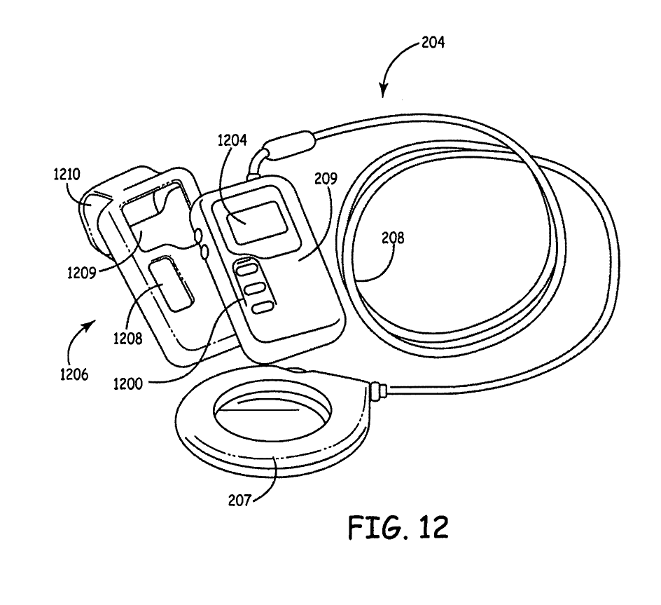

FIG. 12 is a front perspective view illustrating one embodiment of external charging device 204 (FIG. 2) in more detail. External charging device 204 includes an external antenna 207 and a charging unit 209 that contains the electronics necessary to drive a primary coil in the antenna 207 with an oscillating current. This induces a current in a secondary coil of pectorally-implanted IMD 103 when the primary coil in the antenna 207 is in the proximity of the secondary coil. Charging unit 209 is preferably operatively coupled to the primary coil in the antenna 207 by cable 208. Controls 1200 are provided on the front of charging unit 209 to allow patient 100 or a clinician to initiate and control the recharging of pectorally-implanted IMD 103. Status regarding operation of charging unit 209 may be provided via display screen 1204 of charging unit 209.

In the illustrated embodiment, external antenna 207 is annular. The external circumference of antenna 207 is of a size that can be received by holder 314. In one embodiment, the internal diameter of antenna 207 is somewhat smaller than the internal diameter of panel 602. As a result, when antenna 207 is inserted into the pocket between panels 600 and 602 (FIG. 6) of holder 314, at least a portion of the surface of antenna 207 that is proximal to panel 602 will be in contact with the patient's body. This will provide for better recharging efficiency.

FIG. 12 further includes an optional holder 1206 that receives charging unit 209 of external charging device 204. Holder 1206 may be fashioned to include a cutaway portion 1208 that allows patient to access controls 1200. A second cutaway portion 1209 may be provided to view display screen 1204 of charging unit 209. Holder 1206 may be coupled to torso strap 302 or another belt worn by the patient via a belt clip (not shown in FIG. 12). Alternatively, holder 1206 may be carried in a pocket of the patient's clothing, attached to a hook provided by torso strap, attached to a hook of shoulder strap, or carried in some other manner by patient 100. This will be discussed further below.

Holder 1206 may further include a releasable flap 1210 proximate to the top of holder 1206 to allow charging unit 209 to be secured within, and removed from, holder 1206. A fastener (not shown), such as but not limited to hook-and-loop or a snap may be used to releasably connect the flap 1210 to the rear of holder 1206.

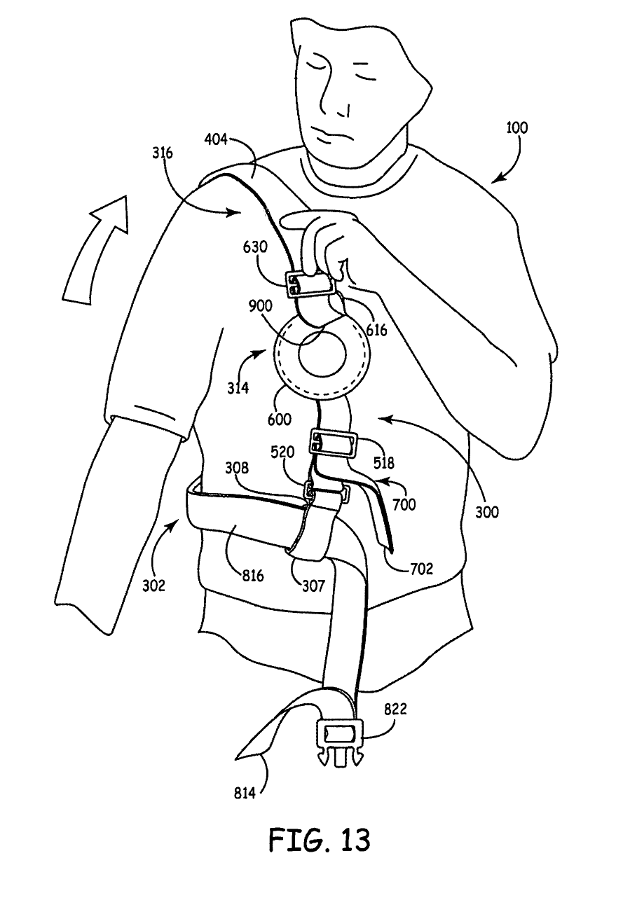

FIG. 13 is a view of patient 100 donning holster 300. This view shows strap 404 of back portion 316 being slid onto the right shoulder of patient 100. End 900 of strap may then be pulled through adjuster 630 to adjust holder 314 to be proximal to pectorally-implantable IMD 103 (not shown in FIG. 13.) Once holder 314 is adjusted in the desired position by adjusting strap 404, strap 700 may likewise be adjusted. In particular, patient may pull end 702 of strap 700 through adjuster 518 to position torso strap 302 at a desired height around the patient's torso. The current view illustrates torso strap 302 lying approximately at the patient's waist. Alternatively, torso strap 302 may be positioned to encircle the patient above the waist, such as around the chest of the patient if desired. In another configuration, the torso strap 302 may be positioned somewhat below the waistline of patient 100.

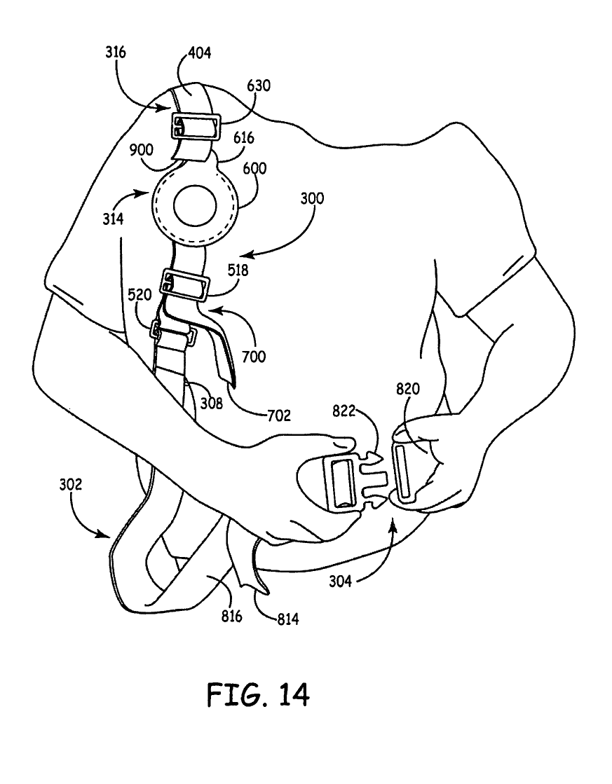

FIG. 14 is a front view of a patient who has positioned strap 404 of back portion 316 over the right shoulder. The patient is in the process of engaging male portion 822 with female portion 820 of fastener 304 so that torso strap 302 encircles his torso.

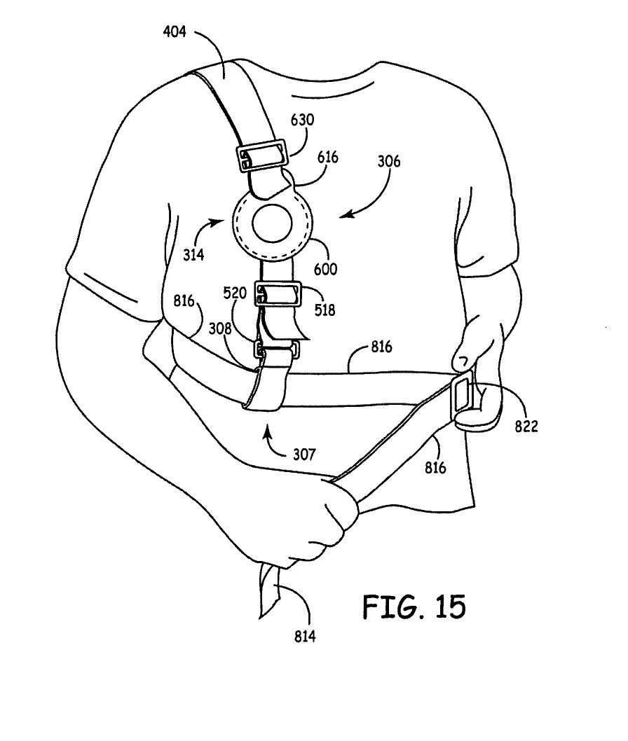

FIG. 15 is a front view of the patient adjusting the length of torso strap 302. To tighten the torso strap 302, the patient grasps male portion 822 of fastener 304 and exerts force on end 814 of the torso strap. This allows male portion 822 to slide to a desired point along intermediate portion 816 of strap that is closer to where loop 308 of shoulder strap 306 is positioned. Conversely, to loosen torso strap 302, patient may grasp a point of intermediate portion 816 of torso strap and exert force so that male portion 822 is slid closer to end 814.

FIG. 15 illustrates that loop 308 of shoulder strap 306 may be adjustably positioned at any point along intermediate portion 816 of torso strap. This allows patient to further “fine-tune” the position of holder 314 to the location proximal to pectorally-implantable IMD 103 (not shown in FIG. 15.)

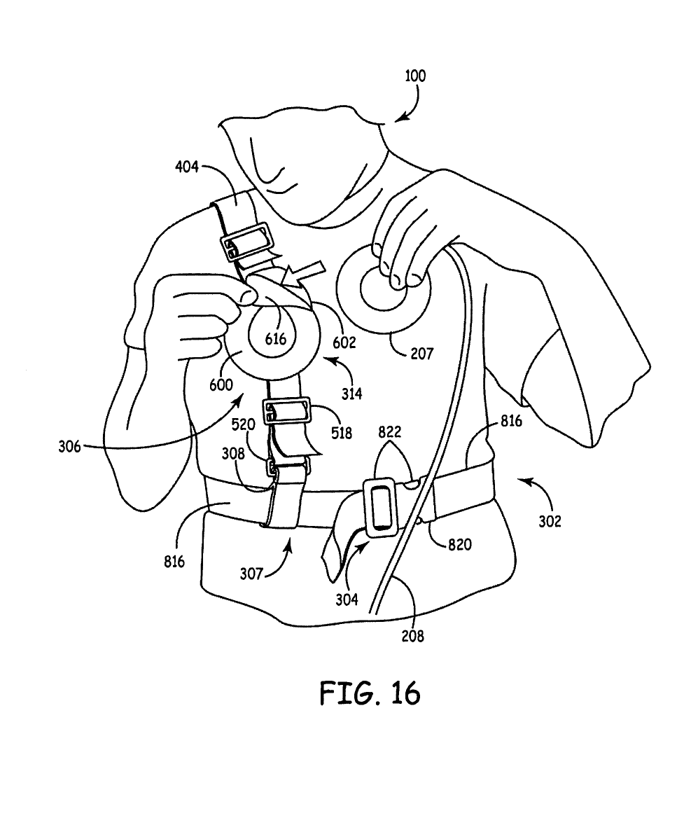

Generally, when shoulder strap 306 is being worn on the right side of patient's body, loop 308 will likewise be positioned to the right side of fastener 304 as shown in FIG. 16. However, this need not be the case. If desired, torso strap 302 could be slid so that fastener 304 is positioned any point on the front, back, left, or right of the patient's torso. For example, in the scenario of FIG. 16, patient may twist torso strap 302 such that loop 308 slides over fastener 304 to a point along intermediate portion 816 that is on the other side of fastener. The patient may want to do this, for example, if the patient prefers to wear torso strap 302 with fastener 304 positioned at his right side.

FIG. 16 is a front view illustrating patient 100 having donned holster 300 and secured male portion 822 to female portion 820 of fastener 304. The patient is inserting an antenna 207 of external charging device 204 into the pocket formed between panels 600 and 602 of holder 314. The patient accesses this pocket by exerting outward force on tab 616 of panel 600. Once the antennal is positioned in this manner, loop 308 of torso strap may be positioned at any desired spot along intermediate portion 816 of torso strap 302, including any point on either side of fastener 304, as discussed above to position antenna proximate to pectorally-implanted IMD. Preferably, to optimize the charge and to reduce the charge time, the inner diameter of holder 314 exposing a contact portion of antenna 207 should correspond with the location of the pectorally-implanted IMD 103. The center of the antenna 207 should be placed over the center of the pectorally-implanted medical device 103. To reduce charge time, movement of the antenna 207 during the recharge session should be minimized.

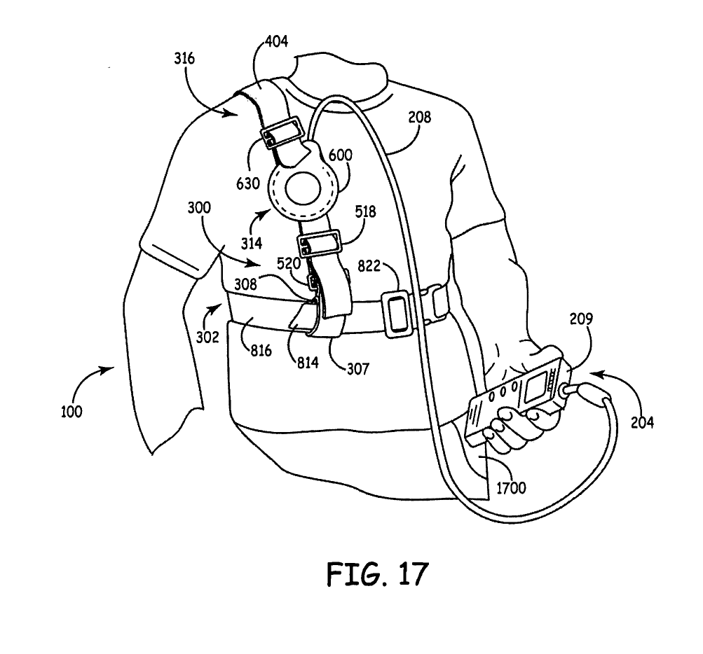

FIG. 17 is a front view of patient 100 holding charging unit 209 of charging device 204. Antenna 207 (not visible in FIG. 17) of charging device 204 has been inserted into holder 314, and is coupled to charging unit 209 via cable 208. Patient may then initiate a charging session wherein charging unit 209 generates a current in antenna 207. This inductively couples antenna 207 to the secondary coil within pectorally-implanted IMD 103 (not shown), thereby recharging a rechargeable power source within IMD 103. Because holster 300 is highly adjustable, allowing antenna 207 to be optimally positioned over IMD 103, recharging can occur in an optimal manner that reduces charging time.

Once patient 100 has initiated a charging session, patient may insert charging unit 209 into a pocket 1700 of clothing, may clip charging unit 209 to torso strap 302 or to another belt worn by the patient, or fasten to any other suitable support structure.

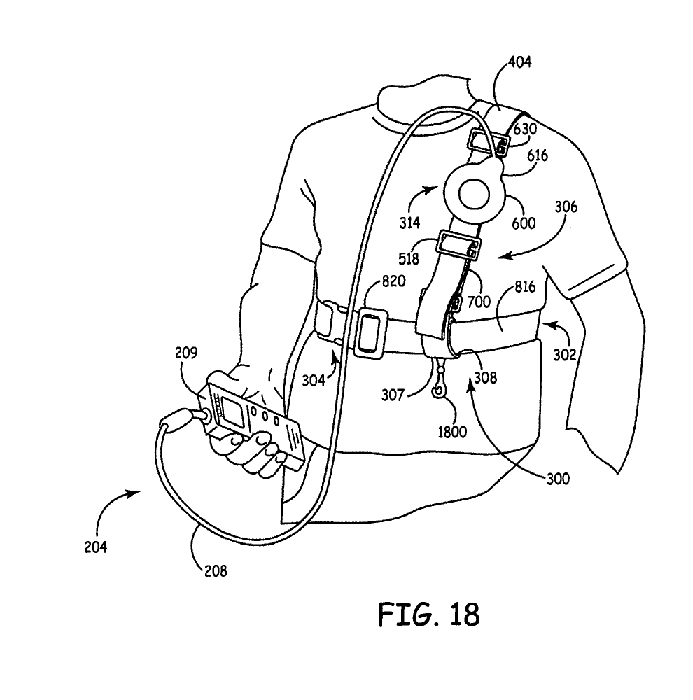

FIG. 18 is a front view of patient 100 who has donned holster 300 on his left side. To optimally position holder 314 proximal to a pectorally-implanted IMD 103 that is implanted on the patient's left side, adjusters 630 and 518 are positioned along a desired point of straps 404 and 700, respectively. Loop 308 of torso strap 302 may then be positioned at any point along intermediate portion 816 of torso strap 302 not otherwise occupied by end 400 of torso strap, including any point either to the left or right of fastener 304.

FIG. 18 further illustrates an optional hook 1800 that is fastened to end 307 of shoulder strap 306. This hook may be provided to engage a clip (not shown in FIG. 18) on charging unit 209. Charging unit 209 may thereby be fastened to clip during a recharge session if desired.

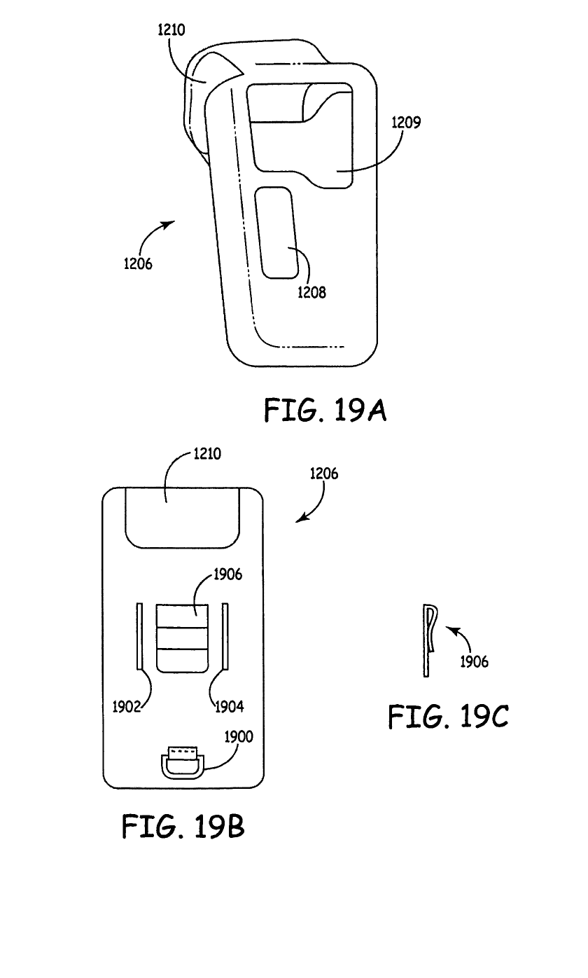

FIG. 19A is a front perspective view of optional holder 1206 for housing charging unit 209. The optional charging unit holder 1206 may be used as a protective sleeve for the charging unit 209 and may be used as a means for connecting the charging unit 209 to a connecting structure such as, but not limited to, torso strap 302, a belt worn by the patient, a pocket, the patient's clothing, or any other suitable connecting structure. The front of the charging unit holder 1206 includes a cutaway portion 1209 proximate the top of holder to allow display 1204 of charging unit 209 to be viewed. A second cutaway portion 1208 is provided below cutaway portion 1209 to allow access to controls 1200 on the charging unit 209. A releasable flap 1210 proximate the top of holder 1206 allows the charging unit 209 to be secured within and removed from holder 1206. A fastener (not shown), such as but not limited to, hook-and-loop or a snap, may be used to releasably connect the flap 1210 to the rear of holder 1206.

FIG. 19B is a back perspective view of holder 1206 for receiving charging unit 209. The rear of the charging unit holder 1206 may include a suitable connector for connecting the charging unit holder 1206 to the connecting structure. An example of a suitable connector is a ring 1900 connected proximate the bottom of the charging unit holder 1206. Ring 1900 may be connected to a hook such as hook 1800 (FIG. 18) which is optionally provided on shoulder strap 306. In the illustrated embodiment, ring 1900 may be coupled to hook with the front of the charging unit holder 1206 facing away from the patient. To view the screen of the charging unit 209, the charging unit holder 1206 is simply pivoted upward toward the patient so that the front of the charging unit holder 1206 faces the patient. Another example of a suitable connector is a first slot 1902 and a second slot 1904 proximate the middle of the charging unit holder 1206. The torso strap 302 or the shoulder strap 306 of the holster 300, a belt, or any other suitable elongate member may be threaded through the slots 1902 and 1904 to connect the charging unit holder 1206 to holster 300, the belt, or the other suitable elongate member. Another example of a suitable connector is a clip 1906 that may be slid onto any suitable connecting structure such as torso strap 302, another belt worn by the patient, a pocket of the patient, or any other suitable connecting structure.

FIG. 19C is a side view of clip 1906 for attaching holder 1206 to torso strap 302 or to another accessory worn by or carried on, patient 100. The holder 1206 may be connected, disconnected, and reconnected to any suitable connecting structure. Alternatively, holder 1206 or charging unit 209 may be placed in the patient's pocket or even hand-held.

As may be appreciated from the foregoing, the holster 300 of the exemplary embodiments is designed so that a patient who is a first-time user will readily comprehend how the various straps are to be donned and configured. For instance, in the illustrated embodiments, torso strap 302 is wider than shoulder strap 306. Moreover, torso strap 302 includes a buckle-type fastener 304. These aspects of holster 300 lead a patient to intuitively associate torso strap 302 with his waist. This conceptualization is enhanced if fastener 304 is chosen to be the only buckle-type fastener in the entire design, as is the case in the exemplary embodiments shown and described herein. The vest portion further guides a first-time user to position back portion 316 of shoulder strap 306 against his back, leading the patient to pull shoulder strap 306 over one shoulder. These factors allow a user to correctly don the system with little or no guidance from an external source. Ease of use may further be enhanced by making the shoulder strap 306 a different color from torso strap 302, if desired.

Once holster 300 is donned, the system is designed to allow the user to readily make adjustments so that the holster meets his preferences and needs. In most cases, these adjustments can be made with one hand, as may be necessary if charging unit 209 is being held in the other hand. Moreover, structures such as charging unit holder 1206 and hook 1800 (FIG. 18) allow charging unit 209 to be entirely supported by holster 300 so that both of the patient's hands are free to make adjustments, if needed. These features contribute to a system that is both easy to understand and simple to configure and use.

Exemplary embodiments of a holster are discussed above. Those skilled in the art will appreciate that alternative embodiments are possible within the scope of the invention. For example, vest 406 of back portion 316 may take different shapes and sizes. If desired, the sides of vest 406 may be extended to encircle a portion of the patient's torso. One or more pockets may be provided in vest 406 to receive charging unit 209 during a recharge session.

Alternative embodiments may likewise be provided to allow end 307 to be selectively positioned relative to torso strap 307. In the foregoing embodiments, this positioning is accomplished by moving loop 308 of shoulder strap 306 to selectively position end 307 at any point along intermediate portion 816 of torso strap 302. In another embodiment, this loop 308 could be replaced by some other mechanism such as a strip of hook-and-loop fasteners that are adapted to mate with hook-and-loop fasteners provided along part, or all, of the length of intermediate portion 816 of torso strap 302. In yet another embodiment, snaps provided on end 307 could be provided to mate with selected ones of opposing snaps provided along the length of intermediate portion 816 of torso strap 302. Many other mechanisms for selectively positioning end 307 at a point along intermediate portion 816 are possible.

As another example, the current embodiments contemplate that holder 314 receives antenna 207 of external recharging device 204. In another embodiment, holder 314 may be sized to receive both the antenna 207 and charging unit 209.

The above specification, examples and data provide a complete description of the manufacture and use of the composition of the invention. Since many embodiments of the invention can be made without departing from the spirit and scope of the invention, the invention resides in the claims hereinafter appended.

We claim:

1. A holster to receive a power source for transcutaneously powering a pectorally-implanted IMD in a patient having a torso, a back, and a shoulder, comprising:
a torso strap adapted to receive the torso of the patient, the torso strap having first and second ends and an intermediate portion there between; and
a shoulder strap to receive the shoulder of the patient, the shoulder strap having a first end operatively coupled to the intermediate portion and a second end slidably positionable anywhere along the intermediate portion of the torso strap when the first and second ends of the torso strap are coupled together, the shoulder strap being adapted to support at least an antenna of the power source adjacent the pectorally-implanted IMD.

2. The holster of claim 1, wherein the second end of the shoulder strap forms a loop that slidably engages the intermediate portion of the torso strap.

3. The holster of claim 1, wherein the first and second ends of the torso strap are releasably-connectable, and the second end of the shoulder strap is adapted to slide over the first and second ends of the torso strap when the first and second ends of the torso strap are connected.

4. The holster of claim 1, wherein the first end of the shoulder strap is slidably-coupled to the torso strap.

5. The holster of claim 1, wherein the shoulder strap includes a holder having a cavity adapted to receive at least an antenna of the power source.

6. The holster of claim 5, wherein the shoulder strap further includes a back portion that provides the first end of the shoulder strap, the back portion including a strap that is coupled to the holder.

7. The holster of claim 5, wherein the shoulder strap includes a front portion that provides the second end of the shoulder strap, wherein the holder includes a strap, and wherein the front portion is coupled to the strap of the holder.

8. The holster of claim 5 wherein the shoulder strap includes a front portion and a back portion, and wherein the holder is adjustably coupled to at least one of the front portion and the back portion.

9. The holster of claim 1, wherein the shoulder strap includes a vest adapted to receive the back of the patient.

10. The holster of claim 1, wherein the torso strap is adjustable.

11. The holster of claim 1, further including a holder adapted to receive a charging unit of the power source.

12. A method of transcutaneously powering a pectorally-implanted IMD with a power source, comprising:
donning a torso strap having a first end, a second end that is releasably coupled to the first end, and an intermediate portion between the first and second ends;
donning a shoulder strap supporting at least an antenna of the power source, the shoulder strap having a first end and a second end, each of the first end and the second end of the shoulder strap being coupled to the intermediate portion of the torso strap; and
while the first end and the second end of the torso strap are coupled together, slidably positioning the second end of the shoulder strap at any location on the intermediate portion of the torso strap not otherwise occupied by the first end of the shoulder strap to position the antenna proximate to the pectorally-implanted IMD.

13. The method of claim 12, further including adjusting the first end of the shoulder strap to any position along the intermediate portion of the torso strap not occupied by the second end of the shoulder strap.

14. The method of claim 12 wherein the first end of the shoulder strap includes a pocket, and further including slidably-positioning the pocket along the intermediate portion of the torso strap.

15. The method of claim 12 including supporting a charging unit of the power source on a selected one of the shoulder strap and the torso strap.

16. The method of claim 12 including:
supporting a portion of the power source via at least one of the torso strap and the shoulder strap; and
coupling the portion of the power source to the antenna of the power source.

17. The method of claim 12, wherein the shoulder strap includes a front portion, a back portion, and a holder to receive the antenna, and further including adjustably positioning the holder relative to at least one of the front portion and the back portion.

18. The method of claim 12, wherein at least one of the shoulder strap and the torso strap have an adjustable length, and including adjusting the length of at least one of the shoulder strap and the torso strap to position the antenna proximate to the pectorally-implanted IMD.

19. A holster adapted to receive a power source for transcutaneously powering a pectorally-implanted IMD in a patient having a torso and a shoulder, comprising:
a shoulder strap having a first end and a second end and being adapted to support at least an antenna of the power source; and
a torso strap having a first end, a second end, and an intermediate portion there between, at least one of the first and the second end of the shoulder strap being slidably positionable along any point on the intermediate portion of the torso strap not occupied by the other end of the shoulder strap.

20. The holster of claim 19 wherein the shoulder strap has a holder to support an antenna of the power source.

21. The holster of claim 20, wherein the shoulder strap further includes a vest portion adapted to encircle at least a portion of a back of the patient.

22. The holster of claim 21, wherein the vest portion is adjustably-coupled to the holder.

23. The holster of claim 20, wherein the shoulder strap includes a front portion adjustably-coupled to the holder and providing the second end.

24. The holster of claim 19, wherein the second end of the shoulder strap includes a loop slidably engaging the torso strap.

25. The holster of claim 19, wherein the power source includes a recharging unit, and further including at least one support structure coupled to at least one of the shoulder strap and the torso strap to support the recharging unit.
